(19) United States
(12) Patent Application Publication
(10) Pub. No.: US 2015/0071343 A1
(43) Pub. Date: Mar. 12, 2015

(54) METHODS AND APPARATUSES INCLUDING AN ENCODING SYSTEM WITH TEMPORALLY ADAPTIVE QUANTIZATION

(71) Applicant: Magnum Semiconductor, Inc., Milpitas, CA (US)

(72) Inventor: Pavel Novotny, Waterloo (CA)

(73) Assignee: Magnum Semiconductor, Inc., Milpitas, CA (US)

(21) Appl. No.: 14/025,522

(22) Filed: Sep. 12, 2013

(51) Int. Cl. H04N 19/124; H04N 19/172; H04N 19/196; H04N 19/51

(52) U.S. Cl. CPC H04N 19/0009; H04N 19/00587; H04N 19/00266; H04N 19/00381
USPC 375/240.03

(57) ABSTRACT

Examples methods and apparatuses including an encoding system with temporally adaptive quantization are described herein. An example apparatus may include an encoding system configured to receive a coding unit of a video signal. The coding unit may include a plurality of sub-coding units. The encoding system may be further configured to determine spatial complexity statistics and motion estimation statistics associated with a sub-coding unit of the plurality of sub-coding units. The encoding system may be further configured to modify a quantization parameter associated with the coding unit based on the spatial complexity statistics and the motion estimation statistics, and to encode the sub-coding unit using the modified quantization parameter.

### TECHNICAL FIELD

Embodiments described relate to video encoding, and include an encoding system with temporally adaptive quantization.

### BACKGROUND

Typically, signals, such as audio or video signals, may be digitally encoded for transmission to a receiving device. Video signals may contain data that is broken up in frames over time. Due to high bandwidth requirements, baseband video signals are typically compressed by using video encoders prior to transmission/storage. Video encoders may employ a coding methodology to encode macroblocks within a frame using one or more coding modes. In many video encoding standards, such as MPEG-1, MPEG-2, MPEG-4, H.261, H.262, H.263, H.264, etc., a macroblock denotes a square region of pixels, which is 16×16 in size. Most of the coding processes (e.g. motion compensation, mode decision, quantization decision, etc.) occur at this level. Modern block based video coding standards take advantage of temporal and spatial redundancy of a channel to achieve efficient video compression, but produce variable bitrate (VBR) bitstreams.

As complexity of content of the channel changes, the bitrates of the encoded bitstreams may vary over time. A quantification of complexity is often specific to a video coding methodology and an encoder used to encode the content. One issue with encoded bitstreams is managing the variability of the bitrates to efficiently use available bandwidth, while maintaining consistent video quality. In order to control an output bitrate for an encoded bitstream, a rate controller may assign a quantization parameter (QP) for a frame based on an evaluation of complexity of the frame. However, complexity within a frame may vary greatly from macroblock to macroblock. Using a frame-level QP value to encode macroblocks of a frame may produce an encoded frame with noticeable visual quality differences within the frame.

### BRIEF DESCRIPTION OF THE DRAWINGS

FIG. 1 is a block diagram of an encoding system with temporally adaptive quantization according to an embodiment of the disclosure;

FIG. 2 is a block diagram of an encoding system with temporally adaptive quantization according to an embodiment of the disclosure;

FIG. 3 is illustration of comparing sequential frames of a video signal according to an embodiment of the disclosure;

FIG. 4 is a schematic illustration of a media delivery system according to an embodiment of the disclosure; and

FIG. 5 is a schematic illustration of a video distribution system that may make use of a media delivery system described herein.

### DETAILED DESCRIPTION

Certain details are set forth below to provide a sufficient understanding of embodiments of the disclosure. However, it will be clear to one having skill in the art that embodiments of the disclosure may be practiced without these particular details, or with additional or different details. Moreover, the particular embodiments described herein are provided by way of example and should not be used to limit the scope of the disclosure to these particular embodiments. In other instances, well-known video components, encoder or decoder components, circuits, control signals, timing protocols, and software operations have not been shown in detail in order to avoid unnecessarily obscuring the disclosure.

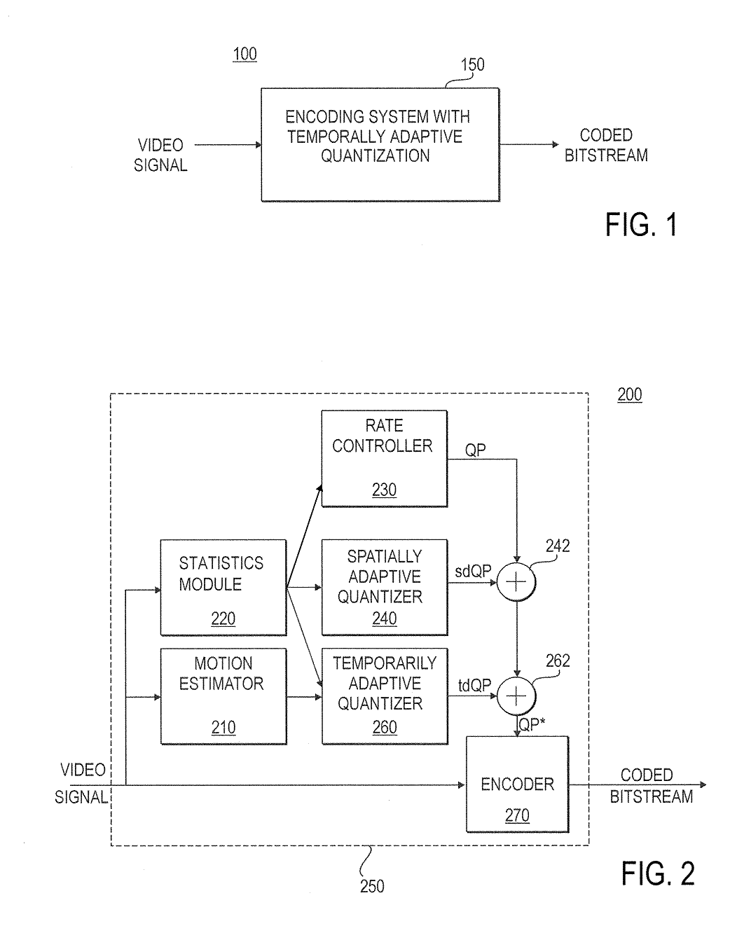

FIG. 1 is a block diagram of an apparatus including an encoding system with temporally adaptive quantization (encoding system) 150 according to an embodiment of the disclosure. The encoding system 150 may be implemented in hardware, software, firmware, or combinations thereof, and may include control logic, logic gates, processors, memory, and/or any combination or sub-combination of the same, and may be configured to encode and/or compress a video signal to provide an encoded bitstream using one or more encoding techniques.

As previously described, the encoding system 150 may receive a video signal, and generate an encoded bitstream based on the video signal using one or more encoding techniques. The video signal may be divided into coding units. Examples of coding units may include frames, sub-frames, regions, fields, macroblocks, etc. In the interest of clarity, operation of the encoding system 150 will discussed in terms of frames as coding units, and macroblocks as sub-coding units. The encoded bitstream may be a variable bitrate bitstream, with variance based on, for example, a complexity of the frames of the video signal. Examples of variables that may affect complexity may include spatial complexity of a frame (e.g., texture) and temporal complexity of a frame (e.g., motion).

In operation, the encoding system 150 may utilize a rate controller to determine a quality level with which to encode a frame of the video signal. The main quality driving parameter may be the quantization parameter (QP). The encoding system 150 may use standard methods for calculating a frame-level QP value, such as based on spatial complexity statistics for a frame. The encoding system 150 may then use adaptive quantization to adjust the assigned frame-level quality level for individual macroblocks of a current frame based on spatial and/or temporal complexities. For example, the encoding system 150 may determine intra-frame spatial statistics and/or motion estimation statistics associated with a macroblock. The encoding system 150 may then use adaptive quantization to adjust the frame-level QP value based on the spatial complexities of the macroblock, and may use temporally adaptive quantization to further adjust the frame-level QP value based on the motion complexities of the macroblock.

Balancing the visual quality of moving and stationary areas, or more precisely changing and not changing areas (e.g., in motion versus not in motion), may present a complex problem. The video quality of areas of a frame that are changing (e.g., in motion) do not need to be as high as areas that are relatively stationary to maintain a particular quality level. This is due to the area that is changing providing a temporal masking effect, where the human eye does not have enough time to detect video quality due to the movement. Conversely, a stationary or a stable area (e.g., not in motion) does not provide any form of temporal masking, and the human eye has the time to evaluate the video quality. Additionally, if an area of a frame is stationary or stable, it may be easier to distinguish between changes of the content and un-natural compression artifacts (e.g., beating, shimmering, and washout texture). Therefore, reducing a quality of areas of a frame that are changing or in motion, and increasing the quality of areas of the frame that are stationary, may provide a perceived video quality across the frame that is more consistent than adjusting for only spatial complexities. Therefore, by spatially and temporally adapting the visual quality based on spatial and motion complexities within a frame, the encoding system 150 may provide an encoded frame that has improved video quality balance across the frame as compared with using a common frame-level QP value for an entire frame.

The spatial complexity statistics may include an average pixel value (DC), and an activity variance. The activity variance represents pixel value variance from the DC value (e.g. the average) for the macroblock. The activity variance may indicate a complexity of texture of the macroblock. The encoding system 150 may provide a spatial QP value adjustment (e.g., sdQP) based on the DC value and the activity variance of the macroblock, which may be used to adjust the frame-level QP value assigned by the rate controller. Generally, the more activity variance (e.g., texture) within a macroblock, the harder it may be for the human eye to notice or distinguish visual quality defects. Thus, a macroblock with more activity variance (e.g., texture) may be encoded at a lower quality than a frame with little or no more activity variance (e.g., texture). For example, the encoding system 150 may set the sdQP value to increase the frame-level QP value (e.g., decrease a video quality) when the macroblock has a large amount of activity variance. Additionally, the encoding system 150 may set the sdQP value to decrease the frame-level QP value (e.g., increase a video quality) when the macroblock has a small amount of activity variance.

Motion estimation statistics may include bidirectional motion estimation of an incoming macroblock. The motion estimation may provide an indication of how well a macroblock may be motion compensated. The motion estimation may include macroblock differences, which may include absolute pixel differences between macroblocks of frames in the forward and/or backward directions. Thus, the encoding system 150 may determine whether a macroblock can be found in a previous or next frame, and whether, if found, the macroblock is stationary or includes some amount of motion. Along with the motion estimation, a macroblock activity may be calculated for all macroblocks in each frame. The macroblock activity may be determined using frames, fields, or adaptively frame or field on a macroblock level based on the video content. In an example for a macroblock that has 16 pixels, the macroblock activity ratio (e.g., sa_ratio) may be calculated as follows:

sa_ratio=min(16, 16*min(SADfw, SADbw)/act

where sa_ratio is an activity ratio for a macroblock in a current frame, SADfw is a sum of absolute pixel differences of a best matched macroblock of the previous frame, SADbw if a sum of absolute pixel differences of a best matched macroblock of the next frame, and act is a sum of absolute pixel differences is both the horizontal and vertical directions in the current frame, which may be calculated as follows:

act=Σ_{y=0}¹⁵Σₓ₌₀¹⁴|pixel_{x,y}−pixel_{x+1,y}|+Σ_{y=0}¹⁴Σₓ₌₀¹⁵|pixel_{x,y}−pixel_{x,y+1}|

In this manner, act may be calculated by summing the absolute differences between neighboring pixels in a x direction for each row in a frame, and by adding to that a sum of the absolute differences between neighboring pixels in a y direction for each column in a frame. The SAD sum of absolute pixel difference between the current macroblock and the reference motion compensated macroblock (e.g., for a previous (SADfw) or next frame (SADbw)) may be calculated as follows:

SAD=Σ_{y=0}¹⁵Σₓ₌₀¹⁵|curr_pixel_{x,y}−ref_pixel_{x,y}|

where curr_pixel_{x,y} is a pixel of the current macroblock, and ref_pixel_{x,y} is a pixel of a reference macroblock (e.g., for a previous (SADfw) or next frame (SADbw)).

The act value may normalize the motion of a macroblock by an amount of activity (e.g., texture) within the macroblock. The sa_ratio may be rounded to an integer value between 0 and 16, and limited to a maximum value of 16 in some examples. The sa_ratio may provide an indication of how much the macroblock is changing. A value of 0 may correspond with an example where the macroblock is not changing at all. A value of 16 may correspond with an example where the macroblock is undergoing extensive changes. If the macroblock is not changing at all (e.g., the sa_ratio is closer to 0), the frame-level QP value may be decreased (e.g., higher video quality) because the human eye has more time to judge the quality of stationary areas of a screen. If the macroblock is changing extensively (e.g., the sa_ratio is closer to 16), the frame-level QP value may be increased (e.g., lower video quality) because the motion may mask the effects of lower quality to the human eye. Using the minimum of the SAD_{fw} or the SAD_{bw} values for the sa_ratio may immediately detect an area of a screen that becomes stationary, in order to adjust the video quality for the stationary area.

For example, when a car is moving through a frame, a portion of a current frame just behind the car may be compared with a corresponding portion of a next frame that most closely matches the portion of the current frame. Since a macroblock of the current frame for the area behind the car would closely match a macroblock of a next frame, the encoding system 150 may be able to determine that the area behind the car is becoming relatively stationary. Therefore, the encoding system 150 may decrease the frame-level QP value (e.g., increase the quality) of the macroblock of the current frame due to the determination that the macroblock is not in motion.

Based on the sa ratio, the encoding system 150 set a temporal change in QP (e.g., tdQP) value that adjusts the frame-level QP value. In some embodiments, the sa_ratio may be mapped to a value increase or decrease for the QP. In an example, the tdQP value may be determined as follows:

tdQP=SAR_to_{—}DQP[sa_ratio]/4

where SAR_to_DQP is:

SAR_to_{—}DQP={−39, −32, −27, −22, −19, −16, −13, −10, −8, −6, −4, −1,1, 2, 4, 5}

The above mapping from the sa_ratio value to the tdQP value is exemplary. Other embodiments may use different mapping values. Further, the sa_ratio may be limited to a maximum value other than 16. Modifying of the QP value may be done based on a smaller or larger section than a macroblock, such as at a field or region of a frame.

An encoder of the encoding system 150 may receive the frames of the video signal. Responsive to receipt of the frames, the encoder may encode the frames in accordance with one or more encoding methodologies or standards, such as MPEG-2, MPEG-4, H.263, H.264, and/or HEVC, and based on the frame-level QP value selected by the rate controller that has been modified (e.g., adjusted) based on spatial complexity and/or motion estimation. The encoded frames may be provided in the encoded bitstream.

FIG. 2 is a block diagram of an apparatus including an encoding system with temporally adaptive quantization (encoding system) 250 according to an embodiment of the disclosure. The encoding system 250 may be implemented in hardware, software, firmware, or combinations thereof, and may include control logic, logic gates, processors, memory, and/or any combination or sub-combination of the same, and may be configured to encode and/or compress a video signal to provide an encoded bitstream using one or more encoding techniques. The encoding system 250 may be used to implement the encoding system 150 of FIG. 1.

The encoding system 250 may include a statistics block 220 and a motion estimator that each receive the video signal. The statistics block 220 may provide statistical information for a frame or a macroblock that indicates spatial complexity based on the video signal to a rate controller 230, a spatially adaptive quantizer 240, and a temporally adaptive quantizer 260. As explained with reference to FIG. 1, the spatial complexity statistics may include an average pixel value (DC), and an activity variance. The activity variance represents pixel value variance from the DC value for the macroblock. The activity variance may indicate a complexity of texture of the macroblock.

The rate controller 230 may provide a frame-level QP value based on the spatial complexity statistics for the entire frame to an adder 242. The spatially adaptive quantizer 240 may provide a spatial QP value adjustment (e.g., sdQP) to the adder 242 based on the spatial complexity statistics for a current macroblock of the frame (e.g., the DC value and the activity variance of the macroblock). The adder 242 may adjust the frame-level QP value provided by the rate controller 230 based on the sdQP value (e.g., raise the frame-level QP value for high activity variance or lower the frame-level QP value for low activity variance).

The encoding system 250 may further include a motion estimator 210 that is coupled to a temporally adaptive quantizer 260. The temporally adaptive quantizer 260 may be further coupled to the spatially adaptive quantizer 240. The motion estimator 210 may receive the video signal and may provide motion estimation statistics associated with a macroblock and/or a frame to the temporally adaptive quantizer 260. The motion estimation statistics from the motion estimator 210 may include, for example, bidirectional motion estimation of an incoming macroblock of the video signal. The motion estimation may provide an indication of how well the macroblock may be motion compensated.

The temporally adaptive quantizer 260 may provide a temporal QP value adjustment (e.g., tdQP) to the adder 262 based on the motion estimation statistics from the motion estimator 210 and the spatial complexity statistics from the statistics block 220. The adder 262 may modify the QP value output from the adder 242 based on the tdQP value. The adder 262 may provide an adjusted QP* value to the encoder 270.

The encoder 270 may receive coding units via video signal and provide the encoded bitstream at an output that is encoded based on the QP* value. The encoder 270 may be implemented in hardware, software, or combinations thereof. The encoder 270 may include an entropy encoder, such as a variable-length coding encoder (e.g., Huffman encoder, context-adaptive variable length coding (CAVLC) encoder, or context-adaptive binary arithmetic coding (CABAC) encoder), and/or may be configured to encode the frames, for instance, at a macroblock level. Each macroblock may be encoded in intra-coded mode, inter-coded mode, bidirectionally, or in any combination or subcombination of the same. As an example, the encoder 270 may encode the video signal in accordance with one or more encoding methodologies or standards, such as MPEG-2, MPEG-4, H.263, H.264, and/or HEVC. The encoding methodologies and/or standards implemented by each encoder 0-N statistics block 220(0-N) may result in encoded frames having variable bitrates.

In operation, the encoding system 250 may utilize the rate controller 230 to determine a frame-level QP value with which to encode a frame of the video signal. The rate controller 230 may use standard methods for calculating the QP on the frame-level. Then, as previously described, the encoding system 250 may use adaptive quantization to adjust the assigned frame-level quality level for individual macroblocks of the frame based on spatial and/or temporal complexities. For example, for a given macroblock, the statistics block 220 may determine intra-frame spatial complexity statistics and/or the motion estimator 210 may determine motion estimation statistics. The spatially adaptive quantizer 240 may set a value of a sdQP to adjust the frame-level QP value based on the spatial complexity statistics, and the temporally adaptive quantizer 260 may set a value of the tdQP to further adjust the frame-level QP value based on the motion complexities of the macroblock. By spatially and temporally adapting the visual quality based on spatial and motion complexities within a frame, the encoding system 250 may provide an encoded frame that has improved video quality balance across the frame as compared with using a common frame-level QP value for an entire frame.

The spatial complexity statistics determined by the statistics block 220 may include an average pixel value (DC), and an activity variance. The spatially adaptive quantizer 240 may provide the sdQP to the adder 242 having a value based on the DC value and the activity variance of the macroblock. As previously described, the greater the activity variance, the lower the quality required for the encoded macroblock. Thus, the spatially adaptive quantizer 240 may provide a sdQP value to the adder 242 that increases the QP value (e.g., decrease a video quality) when the macroblock has a large amount of activity variance, and may provide a sdQP value to the adder 242 that decreases the QP value (e.g., increase a video quality) when the macroblock has a small amount of activity variance. The adder 242 may add the sdQP value to the QP value, and provide an updated QP value to the adder 262.

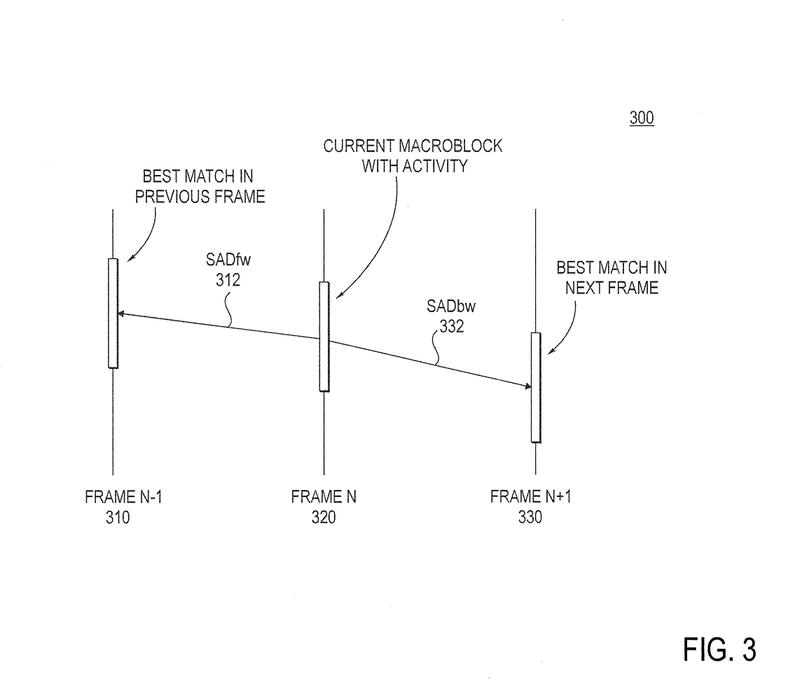

Motion estimation statistics determined by the motion estimator 210 may include bidirectional motion estimation of an incoming macroblock. As previously described, the motion estimation statistics may provide an indication of how well a macroblock may be motion compensated. The motion estimator 210 may determine macroblock differences, which may include absolute pixel differences between macroblocks of frames in the forward and/or backward directions. The temporally adaptive quantizer 260 may use the motion differences to determine whether a macroblock can be found in a previous or next frame, and whether, if found, the macroblock is stationary or includes some amount of motion. For example, in FIG. 3, the when processing macroblocks of the current frame N 320, the temporally adaptive quantizer 260 may determine motion difference with respect to the previous frame N−1 310 and the next frame N+1 330. Along with the motion estimation, the temporally adaptive quantizer 260 may also calculate a macroblock activity for all macroblocks in a frame (e.g., a current frame N 320 of FIG. 3) based on the spatial complexity statistics from the statistics block 220 and the motion estimation statistics from the motion estimator 210. In an example for a macroblock that has 16 pixels, the temporally adaptive quantizer 260 may determine a macroblock activity ratio (e.g., sa_ratio) as follows:

sa_ratio=min(16, 16*min(SADfw, SADbw)/act

where sa_ratio is an activity ration for a macroblock in a current frame (e.g., current frame 320 of FIG. 3), SADfw (e.g., SADfw 312 of FIG. 3) is a sum of absolute pixel differences of a best matched macroblock of the previous frame (e.g., previous frame 310 of FIG. 3), SADbw (e.g., SADbw 332 of FIG. 3) if a sum of absolute pixel differences of a best matched macroblock of the next frame (e.g., next frame N+1 330 of FIG. 3), and act is a sum of absolute pixel differences is both the horizontal and vertical directions in the current frame (e.g., the current frame N 320 of FIG. 3), and may be calculated as follows:

act=Σ_{y=0}¹⁵Σₓ₌₀¹⁴|pixel_{x,y}−pixel_{x+1,y}|+Σ_{y=0}¹⁴Σₓ₌₀¹⁵|pixel_{x,y}−pixel_{x,y+1}|

The SAD sum of absolute pixel difference between the current macroblock and the reference motion compensated macroblock (e.g., a best matched macroblock of a previous (SADfw) or a best matched macroblock of next frame (SADbw)) may be calculated by the temporally adaptive quantizer 260, as follows:

SAD=Σ_{y=0}¹⁵Σₓ₌₀¹⁵|curr_pixel_{x,y}−ref_pixel_{x,y}|

where curr_pixel_{x,y} is a pixel of the current macroblock, and ref_pixel_{x,y} is a pixel of a reference macroblock (e.g., for a previous (SADfw) or next frame (SADbw)).

As previously described, the act value may normalize the motion of a macroblock by an amount of activity (e.g., texture) within the macroblock. Also as previously described, the sa_ratio may be rounded to an integer value between 0 and 16, and may be limited to a maximum value of 16 in some examples. The sa_ratio may provide an indication of how much the macroblock is changing (e.g., the higher the value, the more the macroblock is changing). If the macroblock is not changing at all (e.g., the sa_ratio is closer to 0), the temporally adaptive quantizer 260 may set the value of the tdQP to decrease the frame-level QP value (e.g., increase video quality), and if the macroblock is changing extensively, the temporally adaptive quantizer 260 may set the value of the tdQP to increase the frame-level QP (e.g., lower video quality). Using the minimum of the SAD_{fw} or the SAD_{bw} values for the sa_ratio may allow the temporally adaptive quantizer 260 to detect an area of a screen that becomes stationary (e.g. previously described in the moving car example), in order to adjust the video quality for the stationary area.

Based on the sa_ratio, the temporally adaptive quantizer 260 may provide a temporal change in QP (e.g., tdQP) value to the adder 262 to modify the updated QP value received from the adder 242 to provide the QP* value. The adder 262 may provide the QP* value to the encoder 270. In an example, the temporal change in tdQP value may be determined as follows:

tdQP=SAR_to_{—}DQP[sa_ratio]/4

where SAR_to_DQP is:

SAR_to_{—}DQP={−39, −32, −27, −22, −19, −16, −13, −10, −8, −6, −4, −1,1, 2, 4, 5}

The above mapping from the sa ratio value to the tdQP value is exemplary. Other embodiments may use different mapping values. Further, the temporally adaptive quantizer 260 may set the tdQP value based on a smaller or larger section of a frame than a macroblock, such as at a field or region level of a frame.

The encoder 270 may receive and encode (based on the QP* value value) the video signal that includes the macroblock. The video signal may be encoded in accordance with one or more encoding standards, such as MPEG-2, MPEG-4, H.263, H.264, and/or HEVC, to provide the encoded bitstream. The video signal may be encoded by the encoder 270 based on a quantization strength, which is based on the QP* value received from the adder 262. In encoding content, the encoder 270 may generate a predictor for a macroblock, and may subtract the predictor from the macroblock to generate a residual. The encoder 270 may transform using, for example, a discrete cosine transform (DCT), the residual to provide a block of coefficients. The encoder 270 may quantize the block of coefficients based on the QP* value. The block of quantized coefficients and other syntax elements may be provided to an entropy encoder and encoded into the encoded bitstream. In some embodiments, the block of quantized coefficients may be reconstructed to determine an encoding cost (e.g., inverse quantized and inverse transformed to produce a reconstructed macroblock residual). The reconstructed residual may be used for prediction in encoding subsequent macroblocks and/or frames, such as for further in-macroblock intra prediction or other mode decision methodologies.

Components described herein, including but not limited to the encoding systems, rate controllers, motion estimators, spatial complexity estimators, spatially and temporally adaptive quantizers, and encoders described herein, may be implemented in all or in part using software in some examples. The software may be implemented using instructions encoded on one or more computer readable media. Any electronic storage (e.g. memory) may be used to implement the computer readable media, which may be transitory or non-transitory. The computer readable media may be encoded with instructions for performing the acts described herein, including but not limited to, rate control, encoding, QP selection, temporally or spatial adaptive quantization, motion estimation, spatial complexity calculation, and combinations thereof. The instructions may be executable by one or more processing units to perform the acts described. The processing units may be implemented using any number and type of hardware capable of executing the instructions including, but not limited to, one or more processors, circuitry, or combinations thereof.

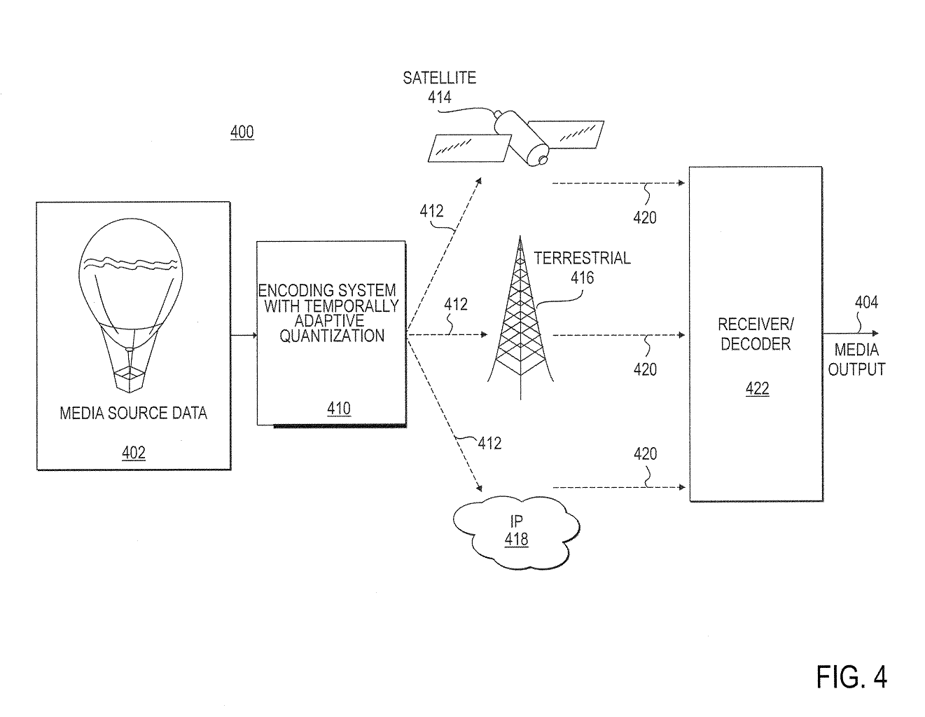

FIG. 4 is a schematic illustration of a media delivery system in accordance with embodiments of the present disclosure. The media delivery system 400 may provide a mechanism for delivering a media source 402 to one or more of a variety of media output(s) 404. Although only one media source 402 and media output 404 are illustrated in FIG. 4, it is to be understood that any number may be used, and examples may be used to broadcast and/or otherwise deliver media content to any number of media outputs.

The media source data 402 may be any source of media content, including but not limited to, video, audio, data, or combinations thereof. The media source data 402 may be, for example, audio and/or video data that may be captured using a camera, microphone, and/or other capturing devices, or may be generated or provided by a processing device. Media source data 402 may be analog or digital. When the media source data 402 is analog data, the media source data 402 may be converted to digital data using, for example, an analog-to-digital converter (ADC). Typically, to transmit the media source data 402, some type of compression and/or encryption may be desirable. Accordingly, an encoding system with temporally adaptive quantization 410 may be provided that may encode the media source data 402 using any encoding method in the art, known now or in the future, including encoding methods in accordance with video standards such as, but not limited to, MPEG-2, MPEG-4, H.264, HEVC, or combinations of these or other encoding standards. The encoding system with temporally adaptive quantization 410 may be implemented using any encoder described herein, including the encoding system 150 of FIG. 1 and/or the encoding system 250 of FIG. 2.

The encoded data 412 may be provided to a communications link, such as a satellite 414, an antenna 416, and/or a network 418. The network 418 may be wired or wireless, and further may communicate using electrical and/or optical transmission. The antenna 416 may be a terrestrial antenna, and may, for example, receive and transmit conventional AM and FM signals, satellite signals, or other signals known in the art. The communications link may broadcast the encoded data 412, and in some examples may alter the encoded data 412 and broadcast the altered encoded data 412 (e.g., by re-encoding, adding to, or subtracting from the encoded data 412). The encoded data 420 provided from the communications link may be received by a receiver 422 that may include or be coupled to a decoder. The decoder may decode the encoded data 420 to provide one or more media outputs, with the media output 404 shown in FIG. 4.

The receiver 422 may be included in or in communication with any number of devices, including but not limited to a modem, router, server, set-top box, laptop, desktop, computer, tablet, mobile phone, etc.

The media delivery system 400 of FIG. 4 and/or encoding system with temporally adaptive quantization 410 may be utilized in a variety of segments of a content distribution industry.

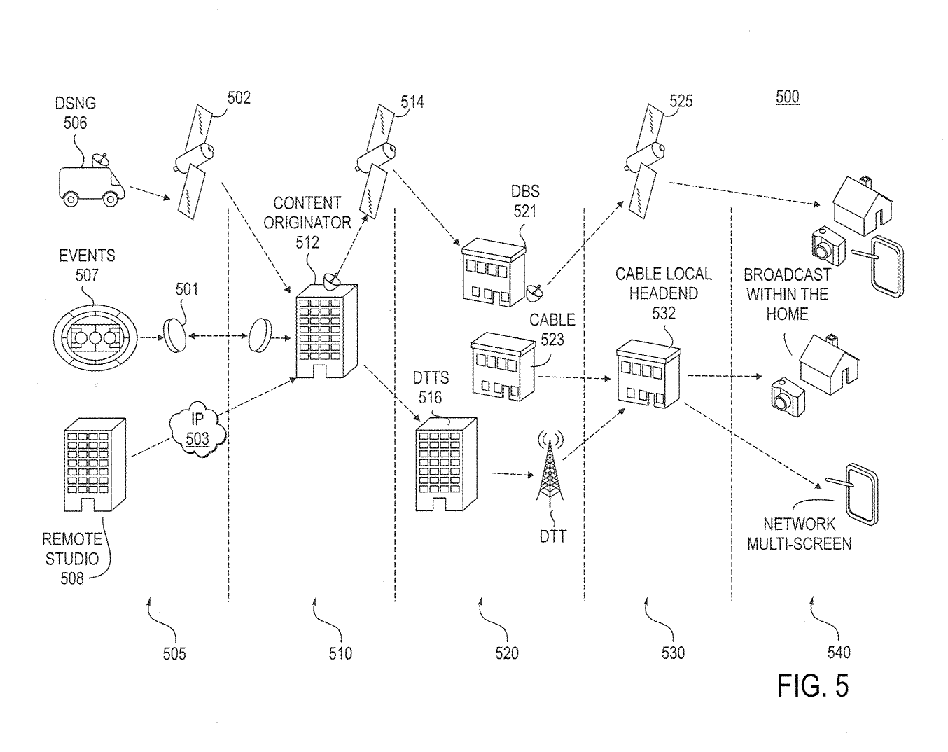

FIG. 5 is a schematic illustration of a video distribution system that 500 may make use of encoders described herein. The video distribution system 500 includes video contributors 505. The video contributors 505 may include, but are not limited to, digital satellite news gathering systems 506, event broadcasts 507, and remote studios 508. Each or any of these video contributors 505 may utilize an encoding system described herein, such as the encoding system with temporally adaptive quantization 410 of FIG. 4, to encode media source data and provide encoded data to a communications link. The digital satellite news gathering system 506 may provide encoded data to a satellite 502. The event broadcast 507 may provide encoded data to an antenna 501. The remote studio 508 may provide encoded data over a network 503.

A production segment 510 may include a content originator 512. The content originator 512 may receive encoded data from any or combinations of the video contributors 505. The content originator 512 may make the received content available, and may edit, combine, and/or manipulate any of the received content to make the content available. The content originator 512 may utilize encoding systems described herein, such as the encoding system with temporally adaptive quantization 410 of FIG. 4, to provide encoded data to the satellite 514 (or another communications link). The content originator 512 may provide encoded data to a digital terrestrial television system 516 over a network or other communication link. In some examples, the content originator 512 may utilize a decoder to decode the content received from the contributor(s) 505. The content originator 512 may then re-encode data; potentially utilizing encoding systems described herein, such as the encoding system with temporally adaptive quantization 410 of FIG. 4, and provide the encoded data to the satellite 514. In other examples, the content originator 512 may not decode the received data, and may utilize a transcoding system (which may consist of an encoding system with temporally adaptive quantization 410 of FIG. 4) to change an encoding format of the received data.

A primary distribution segment 520 may include a digital broadcast system 521, the digital terrestrial television system 516, and/or a cable system 523. The digital broadcasting system 521 may include a receiver, such as the receiver 422 described with reference to FIG. 4, to receive encoded data from the satellite 514. The digital terrestrial television system 516 may include a receiver, such as the receiver 422 described with reference to FIG. 4, to receive encoded data from the content originator 512. The cable system 523 may host its own content which may or may not have been received from the production segment 510 and/or the contributor segment 505. For example, the cable system 523 may provide its own media source data 402 as that which was described with reference to FIG. 4.

The digital broadcast system 521 may include an encoding system, such as the encoding system with temporally adaptive quantization 410 of FIG. 4, to provide encoded data to the satellite 525. The cable system 523 may include an encoding system, such as the encoding system with temporally adaptive quantization 410 of FIG. 4, to provide encoded data over a network or other communications link to a cable local headend 532. A secondary distribution segment 530 may include, for example, the satellite 525 and/or the cable local headend 532.

The cable local headend 532 may include an encoding system, such as the encoding system with temporally adaptive quantization 410 of FIG. 4, to provide encoded data to clients in a client segment 540 over a network or other communications link. The satellite 525 may broadcast signals to clients in the client segment 540. The client segment 540 may include any number of devices that may include receivers, such as the receiver 422 and associated decoder described with reference to FIG. 4, for decoding content, and ultimately, making content available to users. The client segment 540 may include devices such as set-top boxes, tablets, computers, servers, laptops, desktops, cell phones, etc.

Accordingly, encoding, transcoding, and/or decoding may be utilized at any of a number of points in a video distribution system. Embodiments may find use within any, or in some examples all, of these segments.

From the foregoing it will be appreciated that, although specific embodiments of the disclosure have been described herein for purposes of illustration, various modifications may be made without deviating from the spirit and scope of the disclosure. Accordingly, the disclosure is not limited except as by the appended claims.

What is claimed is:

1. An apparatus, comprising:
an encoding system configured to receive a coding unit of a video signal, the coding unit including a plurality of sub-coding units, the encoding system further configured to determine spatial complexity statistics and motion estimation statistics associated with a sub-coding unit of the plurality of sub-coding units, the encoding system further configured to modify a quantization parameter associated with the coding unit based on the spatial complexity statistics and the motion estimation statistics, and encode the sub-coding unit using the modified quantization parameter.

2. The apparatus of claim 1, wherein the encoding system comprises a temporally adaptive quantizer configured to provide a temporal quantization parameter adjustment based on the spatial complexity statistics and the motion estimation statistics associated with the sub-coding unit, wherein the encoding system is configured to add the temporal quantization parameter adjustment to the quantization parameter to produce the modified quantization parameter.

3. The apparatus of claim 2, wherein the temporally adaptive quantizer configured to provide temporal quantization parameter adjustment comprises the temporally adaptive quantizer configured to determine an activity ratio associated with the sub-coding unit, wherein the activity ratio includes a sum of pixel differences associated with at least one of a sub-coding unit of a previous coding unit of the video signal or a sub-coding unit of a coding unit of a subsequent coding unit of the video signal.

4. The apparatus of claim 3, wherein the temporally adaptive quantizer configured to provide temporal quantization parameter adjustment further comprises the temporally adaptive quantizer configured to normalize the activity ratio based on pixel differences within the sub-coding unit.

5. The apparatus of claim 4, wherein the temporally adaptive quantizer configured to normalize the activity ratio based on pixel differences within the sub-coding unit is further configured to calculate a sum of absolute pixel differences of the sub-coding unit in the horizontal and vertical directions.

6. The apparatus of claim 3, wherein the encoding system further comprises a motion estimator configured to calculate the motion estimation statistics by comparing previous and subsequent coding units to the coding unit and to provide the motion estimation statistics to the temporally adaptive quantizer.

7. The apparatus of claim 2, wherein the encoding system further comprises a statistics module that is configured to determine the spatial complexity statistics associated with the coding unit and to provide the spatial complexity statistics to the temporally adaptive quantizer.

8. The apparatus of claim 1, wherein the encoding system further comprises a spatially adaptive quantizer that is configured to provide a spatial quantization parameter adjustment based on the spatial complexity statistics, wherein the encoding system is configured to add the spatial quantization parameter adjustment to the quantization parameter to produce the modified quantization parameter.

9. The apparatus of claim 1, wherein the encoding system further comprises a rate controller that is configured to generate the quantization parameter based on spatial complexity statistics associated with each sub-coding unit of the plurality of coding units of the coding unit.

10. The apparatus of claim 1, wherein the encoding system further comprises an encoder configured to encode the sub-coding unit according to an encoding standard and based on the modified quantization parameter.

11. The apparatus of claim 1, wherein the coding unit is a frame and each of the plurality of sub-coding units are macroblocks.

12. A non-transitory computer-readable medium encoded with instructions comprising instructions that, when executed by one or more processing units, cause the one or more processing units to:
set a quantization parameter for a coding unit of a video signal;
adjust the quantization parameter for the coding unit based on first spatial complexity statistics and first motion estimation statistics associated with a first sub-coding unit of the coding unit to produce a first modified quantization parameter;
encode the first sub-coding unit using the first modified quantization parameter;
adjust the quantization parameter for the coding unit based on second spatial complexity statistics and second motion estimation statistics to produce a second modified quantization parameter; and
encode the second sub-coding unit using the second modified quantization parameter.

13. The non-transitory computer-readable medium of claim 12, wherein the instructions further comprise instructions that when executed by one or more processing units, cause the one or more processing units to:
calculate a first sum of absolute pixel differences between the first sub-coding unit and a third sub-coding unit of a subsequent coding unit;
calculate a second sum of absolute pixel differences between the first sub-coding unit and a fourth sub-coding unit of a previous coding unit;
select a minimum of the first sum of absolute pixel differences and the second sum of absolute pixel differences; and
divide the selected minimum of the first sum of absolute pixel differences and the second sum of absolute pixel differences by a sum of absolute pixel differences of the first sub-coding unit in both the horizontal and vertical directions to produce the motion estimation statistics.

14. The non-transitory computer-readable medium of claim 12, wherein the instructions further comprise instructions that when executed by one or more processing units, cause the one or more processing units to:
calculate an average pixel value of the first sub-coding unit; and
calculate a pixel value variance from the average pixel value for the first sub-coding unit, wherein the spatial complexity statistics include the average pixel value and the pixel value variance from the average pixel value.

15. A method, comprising:
setting a quantization parameter for a coding unit of a video signal at an encoding system;
determining spatial complexity statistics and motion estimation statistics associated with a sub-coding unit of the coding unit;
modifying the quantization parameter for the coding unit based on the determined spatial complexity statistics and the motion estimation statistics to produce a modified quantization parameter; and
encoding the sub-coding unit based on the modified quantization parameter.

16. The method of claim 15, wherein setting the quantization parameter for the coding unit of the video signal comprises:
determining aggregated spatial complexity statistics for all sub-coding unit of the coding unit; and
calculating the quantization parameter value based on the aggregated spatial complexity statistics.

17. The method of claim 16, wherein determining the spatial complexity statistics and the motion estimation statistics associated with the sub-coding unit of the coding unit comprises calculating the spatial complexity statistics by calculating an average pixel value of the sub-coding unit and a pixel value variance from the average pixel value for the sub-coding unit.

18. The method of claim 15, wherein determining the spatial complexity statistics and the motion estimation statistics associated with the sub-coding unit of the coding unit comprises calculating the motion estimation statistics by comparing the sub-coding unit of the coding unit with a sub-coding unit of a previous or subsequent coding unit.

19. The method of claim 18, wherein comparing the sub-coding unit of the coding unit with a sub-coding unit of a previous or subsequent coding unit comprises calculating the sum of absolute pixel differences between the sub-coding unit of the coding unit and the sub-coding unit of the previous or subsequent coding unit.

20. The method of claim 19, wherein calculating the motion estimation statistics further comprises normalizing the sum of absolute pixel differences between the sub-coding unit of the coding unit and the sub-coding unit of the previous or subsequent coding unit based on a sum of absolute pixel differences of the sub-coding unit of the coding unit in both horizontal and vertical directions.

21. The method of claim 15, wherein modifying the quantization parameter for the coding unit based on the determined spatial complexity statistics and the motion estimation statistics comprises increasing the quantization parameter when motion estimation statistics indicate that the sub-coding unit is in motion.

22. The method of claim 15, wherein modifying the quantization parameter for the coding unit based on the determined spatial complexity statistics and the motion estimation statistics comprises decreasing the quantization parameter when motion estimation statistics indicate that the sub-coding unit is stationary.
